(19) United States
(12) Patent Application Publication
(10) Pub. No.: US 2002/0138269 A1
(43) Pub. Date: Sep. 26, 2002

(54) Voice recognition maintenance inspection program

(76) Inventor: Charles F. Philley, San Jose, CA (US)

Correspondence Address: Keith Kline, 14910 Bonner Court, Morgan Hill, CA, 95037-5925, US

(21) Appl. No.: 09/813,601

(22) Filed: Mar. 20, 2001

(51) Int. Cl. G10L 13/08

(52) U.S. Cl. 704/260

(57) ABSTRACT

A method of performing an inspection routine for a vehicle that utilizes a data processing means, a portable computer, that is capable of text-to-speech voice synthesis, and voice recognition technology. The computer is programmed with the complete inspection routine, including drawings and diagrams to illustrate the inspection criteria. The inspector wears the computer while he is performing the inspection, so that the computer can tell the inspector where to go and what to look at. The computer can also ask questions of the inspector to determine the acceptability of the vehicle. If the inspector is unsure regarding a specific point of inspection, the inspector can query the computer, and the inspector will immediately receive help in the form of both audible and visual communications regarding the inspection criteria or inspection technique. Any defects that are discovered during the inspection are automatically reported and documented by the inspector speaking into the portable computer. The inspection data is then downloaded to a database to track corrective action and to provide defect trend analysis.

### BACKGROUND OF THE INVENTION

1. Field of the Invention

The present invention relates generally to inspection routines, and more particularly is a method of automating and standardizing vehicle inspection routines and data gathering for the routines utilizing a portable text-to-speech and voice recognition computer.

2. Description of the Prior Art

Construction of a vehicle, particularly a military vehicle, requires extensive inspection of the work to ensure that the vehicle is properly assembled. Typically, an inspection manual or manuals is/are provided to the person performing the inspection. The inspector follows the documented routine, and records his findings.

This procedure can be very time consuming. Since the routine is often very lengthy, it is generally not feasible for the inspector to memorize the routine. The inspector therefore must continually refer to the documentation. This requires that he stop the inspection, retrieve the manual, check the criteria and/or the next step in the inspection, and then resume the actual inspection.

A significant amount of training time is required to prepare an inspector to properly perform the inspection routines. Therefore, personnel turnover creates the very real possibility of critical variation between inspectors. Moreover, the inspectors may deviate in the amount and quality of the inspection data that they record.

Accordingly, it is an object of the present invention to provide a method of automating an inspection routine for a vehicle.

It is a further object of the present invention to provide a method of providing inspection instructions to an inspector by audible means, and enabling the inspector to audibly record his findings.

It is a still further object of the present invention to provide a system that improves repeatability between different inspectors performing the same inspection routine.

### SUMMARY OF THE INVENTION

The present invention is a method of performing an inspection routine for a vehicle. The method utilizes a data processing means, a portable computer, that is capable of text-to-speech voice synthesis, and voice recognition technology.

The computer is programmed with the complete inspection routine, including drawing information, to provide the inspection criteria. The inspector wears the computer while he is performing the inspection, so that the computer can tell the inspector where to go and what to look at. The computer can also ask questions of the inspector to determine the acceptability of the vehicle. If the inspector is unsure regarding a specific point of inspection, the inspector can query the computer, and the inspector will immediately receive help in the form of both audible and visual communications regarding the inspection criteria or inspection technique.

Any defects that are discovered during the inspection are automatically reported and documented by the inspector speaking into the portable computer. The inspection data is then downloaded to a database to track corrective action and to provide defect trend analysis.

An advantage of the present invention is that it allows an inspector to do a hands-free inspection, that is, the inspection routine instructions are relayed to the inspector by audible means so that the inspector does not need to continually refer to printed matter.

Another advantage of the present invention is that it enables the inspector to record his findings immediately and accurately by simply speaking into the data processing means. Since the data is then downloaded to a database, multiple reporting requirements are easily met. Any number of forms can be completed from the single inspection data database.

A still further advantage of the present invention is that it greatly speeds the inspection process by eliminating reliance on written references, allowing the inspector to operate hands-free.

Another advantage of the present invention is that the use of the data processing means to store the complete inspection routine enhances uniformity of inspection between different inspectors. The ability of the computer to “talk” to the inspector also greatly reduces the training time required for new inspectors.

These and other objects and advantages of the present invention will become apparent to those skilled in the art in view of the description of the best presently known mode of carrying out the invention as described herein.

### DETAILED DESCRIPTION OF THE INVENTION

The present invention is a method of performing an inspection routine for a vehicle. The method utilizes a data processing means, a portable computer, that is capable of text-to-speech voice synthesis, and voice recognition technology. Because of the combination of text-to-speech voice synthesis, and voice recognition technology, the portable computer can essentially “talk” to the inspector, and the computer can respond to verbal commands. Such computers are known in the prior art.

One portable computer that possess the data processing means required for the present invention is the Talkman®. Talkman® is a portable electronic data collection device developed by the Vocollect company in Pennsylvania. The device is designed to be worn on a user's belt, and is powered by a rechargeable battery pack.

The first step in establishing an inspection routine according to the present invention is to program the data processing means with the inspection routine and criteria. Each element that the inspector is to check is programmed into the routine. Drawing criteria can be included so that the inspector can receive audible input during the routine.

During the inspection, the inspector wears the portable computer. The computer can therefore “tell” the inspector exactly what he should be looking at. The computer can provide prompts to the inspector, and can also question the inspector as to certain conditions pertinent to the acceptability of the vehicle. Conversely, if the inspector is uncertain as to an aspect of inspection criteria or the next item to be inspected, the inspector can simply ask the portable computer for instructions or clarification. The computer provides the answer audibly. The computer's input is immediate upon inquiry from the inspector, resulting in a substantial time savings. The inspector is not required to interrupt the routine to refer to a manual or checklist.

Data collection is also greatly simplified, and reporting becomes an almost automatic byproduct of the inspection. Any defects that are discovered during the inspection are documented by the inspector speaking into the portable computer. The inspection data is downloaded to a database following completion of the inspection routine. The inspection data can thus be easily used to track corrective actions taken and to provide defect trend analysis. Redundant documentation requirements are no longer burdensome, due to the fact that once the collected information is loaded into the database, the data can be directed to appear on as many different forms and in as many reports as may be required.

The above disclosure is not intended as limiting. Those skilled in the art will readily observe that numerous modifications and alterations of the device may be made while retaining the teachings of the invention. Accordingly, the above disclosure should be construed as limited only by the restrictions of the appended claims.

I claim:

1. A method of performing an inspection routine comprising:
a) defining said inspection routine,
b) loading said inspection routine into a portable computer, said portable computer including text-to-speech voice synthesis and voice recognition capability so that verbal communication between an inspector and said portable computer is available,
c) affixing said portable computer to the person of the inspector,
d) commencing said inspection routine, wherein during said inspection routine the inspector can query said portable computer concerning routine procedure and inspection criteria, and
e) inputting data collected during said inspection routine into said portable computer.

2. The method as claimed in claim 1 wherein:
following said inspection routine, said data collected during said inspection routine is downloaded from said portable computer to a centralized computer system, said centralized computer system including data compilation and reporting programs.

3. The method as claimed in claim 1 wherein:
drawing criteria is included in said inspection routine so that said drawing criteria is available to said inspector.
